(19) United States
(12) Patent Application Publication
(10) Pub. No.: US 2003/0132093 A1
(43) Pub. Date: Jul. 17, 2003

(54) Safety switch

(76) Inventor: Albert Huang, Taipei (TW)

Correspondence Address: DELLETT AND WALTERS, 310 S.W. FOURTH AVENUE, SUITE 1101, PORTLAND, OR, 97204, US

(21) Appl. No.: 10/037,227

(22) Filed: Jan. 2, 2002

(51) Int. Cl. H02H 7/00; H02H 9/00

(52) U.S. Cl. 200/314; 361/80

(57) ABSTRACT

A safety switch includes a shell having an open top and a closed bottom, with a hollow button pivotally connected to the shell at the open top, and with a first blade, a second blade and a grounding prong extending out of the shell through the closed bottom. A metal piece is housed in the shell and electrically and pivotally connected to an inner end of the second blade. The button has an indicator light received therein. The button is formed with a first tubular portion for receiving a movable pin and a first spring which urges the pin to abut the metal piece. The button is further formed with a second tubular portion for receiving a second spring which is compressed between the grounding prong and the button. Additionally, the indicator light has two terminals electrically connected with the respective spring.

### BACKGROUND OF THE INVENTION

1. Field of the Invention

The present invention relates to a safety switch and, more particularly, to a safety switch which will not be short-circuited inside.

2. Description of Related Art

Many types of safety switches are known. FIG. 4 shows one which includes a shell (40) having an open top and a closed bottom, with a hollow button (50) pivotally connected to the shell (40) at the open top, and a first blade (41), a second blade (42) and a grounding prong (43) extending out of the shell (40) through the closed bottom.

The first blade (41) has a bent inner end formed with a first contact (411), and the second blade (42) has an inner end pivotally connected to a metal piece (60) which is formed with a second contact (61) of platinum.

Furthermore, the hollow button (20) has a tubular portion (53) for receiving a movable pin (55) and a first spring (54), which is so compressed as to urge the pin (55) to abut the metal piece (60).

In the conventional switch, there is a second spring (56) connected to the grounding prong (43) and an indicator light (51) received in the hollow button (50). The indicator light (51) has two terminals (52): one is electrically connected with the first spring (54), and the other is engagable with the second spring (56).

Normally, the blades (41, 42) are connected to each other by the metal piece (60), and the indicator light (51) is lit up by an electrical current passing through the pin (55), the first spring (54), the indicator light (51), the terminals (52) and the grounding prong (43).

However, it has been found that the second spring (56) may bend itself over and contact with the metal piece (60) after the button (50) is repeatedly pressed. As a result, the switch is short-circuited inside, probably resulting in damage or even disaster such as the fire.

Therefore, it is an objective of the invention to provide a safety switch to mitigate and/or obviate the aforementioned problem.

### SUMMARY OF THE INVENTION

The object of the present invention is to provide a safety switch which will not be short-circuited inside.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a preferred embodiment of a safety switch in accordance with the present invention;

FIG. 2 is a cross-sectional view showing the safety switch of FIG. 1 in its closed position;

FIG. 3 is a cross-sectional view showing the safety switch of FIG. 1 in its open position; and

FIG. 4 is a cross-sectional view of a conventional safety switch.

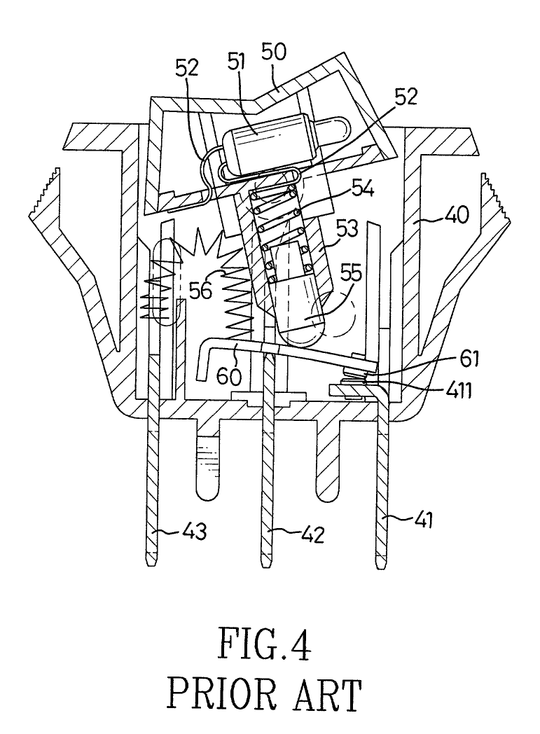

### DETAILED DESCRIPTION OF THE PREFERRED EMBODIMENT

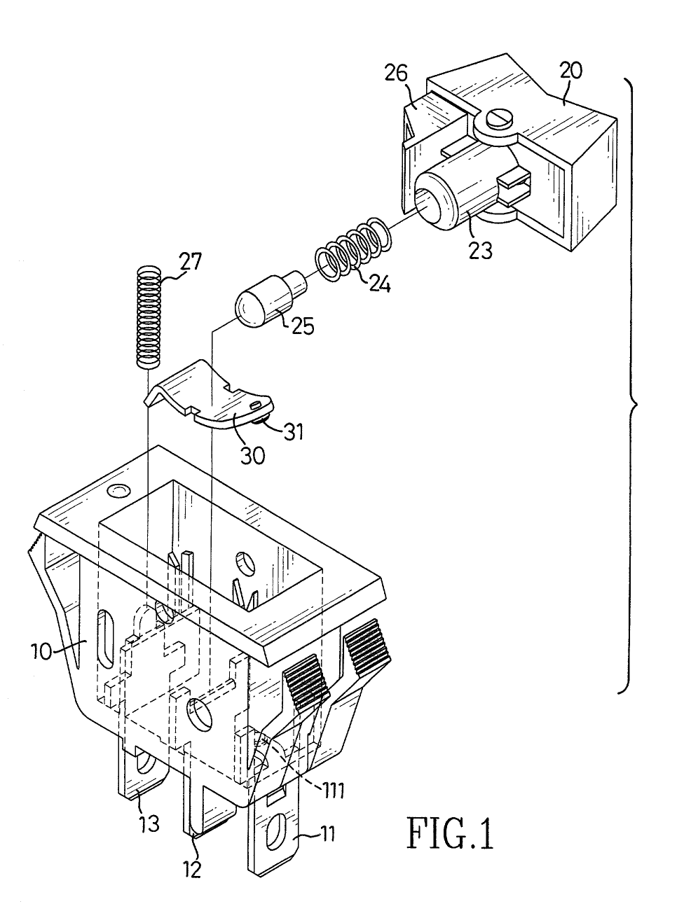

Referring to FIG. 1, a safety switch in accordance with the present invention includes a shell (10) having an open top and a closed bottom, with a hollow button (20) pivotally connected to the shell (10) at the open top.

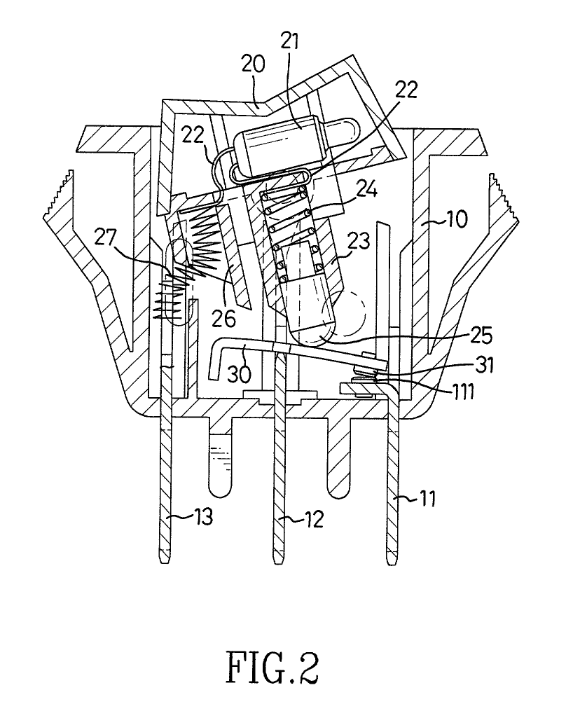

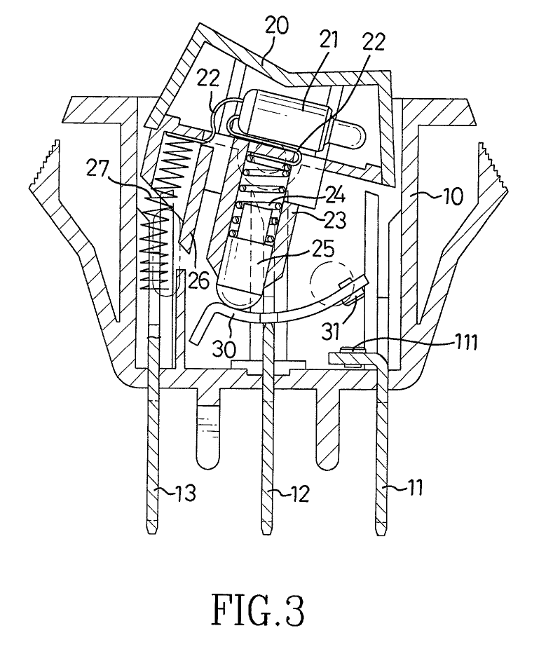

The button (20) is pivotal relative to the shell (10) between a first position, as shown in FIG. 2, and a second position, as shown in FIG. 3.

Referring to FIG. 2, the safety switch is provided with a first blade (11), a second blade (12) and a grounding prong (13), all extending from the interior to the exterior of the shell (10) through its closed bottom.

The first blade (11) has a bent inner end formed with a first contact (111), while the second blade (12), which is located between the first blade (11) and the ground prong (13), has an inner end to which a metal piece (30) is electrically and pivotally connected.

The metal piece (30) is housed in the shell (10) and formed with a second contact (31) of platinum. The metal piece (30) is pivotal relative to the shell (10), but is normally in its first position in which the second contact (31) is brought into contact with the first contact (111) of the first blade (11), as clearly shown in FIG. 2, thus connecting the blades (11, 12) together.

Furthermore, the hollow button (20) has a first tubular portion (23) that extends downward towards the second blade (12) for receiving a movable pin (25) and a first spring (24). The first spring (24) is so compressed in the first tubular portion (23) as to urge the pin (25) to abut the metal piece (30), thereby retaining the button (20) and the metal piece (30) in their first positions.

In the inventive switch, the hollow button (20) additionally has a second tubular portion (26) which extends downward towards the grounding prong (13), for the purpose of receiving or shielding a second spring (27) that is compressed between the grounding prong (13) and the button (20).

It is by the second tubular portion (26) that the second spring (27) and the metal piece (30) are separated from each other and thus no possible short circuit may be established between the second blade (12) and the grounding prong (13).

In the hollow button (20) there is an indicator light (21) having two terminals (22): one extends into the first tubular portion (23) and is electrically connected with the first spring (24), and the other extends into the second tubular portion (26) and is electrically connected with the second spring (27). In this way, the indicator light (21) is normally lit up, indicating the correct connection between the blades (11, 12).

Referring to FIG. 3, the metal piece (30) is heated and warped if an electric overcurrent goes through it as well as the blades (11, 12).

The warped piece (30) will drive the pin (25) to a point at a side of the pivot of the metal piece (30) opposite to the second contact (31). That is, the button (20) and the metal piece (30) are shifted to their second positions, in which the second contact of the metal piece (30) is away from the first contact (111) of the first blade (11), as clearly shown in FIG. 3.

As a result, the blades (11, 12) are disconnected and the electric current is stopped from flowing, thereby avoiding damage to the appliance which causes the overcurrent.

From the above description, it is noted that the invention has the advantage of no possible short circuit between the second blade (12) and the grounding prong (13) because the second tubular portion (26) separates the second spring (27) from the metal piece (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A safety switch comprising:
a shell (10) having an open top and a closed bottom;
a hollow button (20) pivotally connected to said shell (10) at said open top, said button (20) being pivotal relative to said shell (10) between a first position and a second position;
a first blade (11), a second blade (12) and a grounding prong (13) all extending from the interior to the exterior of said shell (10) through said closed bottom, said second blade (12) being located between said first blade (11) and said grounding prong (13);
a metal piece (30) housed in said shell (10) and electrically and pivotally connected to an inner end of said second blade (12), said metal piece (30) being pivotal relative to said shell (10) between a first position, in which said metal piece (30) is in contact with said first blade (11), and a second position, in which said metal piece (30) is away from said first blade (11);
said button (20) being formed with a first tubular portion (23) extending downward towards said second blade (12) and a second tubular portion (26) extending downward towards said grounding prong (13);
a movable pin (25) received in said first tubular portion (23) and abutting said metal piece (30);
a first spring (24) received and compressed in said first tubular portion (23) to urge said pin (25) to abut said metal piece (30);
a second spring (27) at least partially received in said second tubular portion (26) and compressed between the grounding prong (13) and said button (20); and
an indicator light (21) received in said hollow button (20) and having a first terminal (22) and a second terminal (22), said first terminal (22) being electrically connected with said first spring (24), said second terminal (22) being electrically connected to said second spring (27);
whereby said second spring (27) and said metal piece (30) are separated by said second tubular portion (26) of said hollow button (20) and no possible short circuit will be established between said second blade (12) and said grounding prong (13).
